(19) United States
(12) Patent Application Publication
(10) Pub. No.: US 2023/0269274 A1
(43) Pub. Date: Aug. 24, 2023

(54) SECURITY SETTING SUPPORT APPARATUS, SECURITY SETTING SUPPORT METHOD AND PROGRAM

(71) Applicant: Nippon Telegraph and Telephone Corporation, Tokyo (JP)

(72) Inventor: Yuta KAZATO, Musashino-shi, Tokyo (JP)

(21) Appl. No.: 18/014,353

(22) PCT Filed: Jul. 6, 2020
(86) PCT No.: PCT/JP2020/026434

§ 371 Date: Jan. 4, 2023

(51) Int. Cl. H04L 9/40

(52) U.S. Cl. CPC H04L 63/20; H04L 63/1458

(57) ABSTRACT

A security setting support device that supports security setting for a device on a network includes: a preliminary verification unit that performs preliminary verification for determining whether a security setting parameter is settable for the device based on a verification scenario including a feature amount obtained from traffic data in the network and the security setting parameter; and a verification result output unit that outputs a result of the preliminary verification.

### TECHNICAL FIELD

The present invention relates to a technology for providing security setting support in the field of network security.

### BACKGROUND ART

Distributed denial-of-service attacks (DDoS attacks), which obstruct provision of network services and application services, are becoming more sophisticated. In recent years, among the DDoS attacks, a multi-vector DDoS attack is mainly used.

The multi-vector DDoS attack is a DDoS attack in which a plurality of attack methods belonging to an infrastructure layer attack (layer 3 and layer 4 in the OSI model) and an application layer attack (layer 6 and layer 7) are combined.

In order to protect service provision from the multi-vector DDoS attack, it is necessary to detect a DDoS attack by use of a plurality of on-premises devices, cloud devices, security services, and the like and handle the DDoS attack. For example, it is conceivable to use a network device having a transfer function, a security device such as a web application firewall (WAF) or an intrusion prevention system (IPS), a cloud type DDoS mitigation service, or the like.

In addition, in a case where a plurality of devices and security services are used, it is necessary to perform security setting for each introduction of each device and security service in accordance with the configuration of a network, requirements for providing a new application service, and an SLA of the application service. In particular, in a cloud-native network (NW), since the NW configuration and the NW environment are flexibly changed, it is necessary to review and tune security settings each time the NW configuration or the NW environment is changed.

As a conventional technology related to detection and handling of a DDoS attack, there is a method of setting a threshold value in a security device or the like (Non Patent Literature 1 and Non Patent Literature 2). In this method, for example, in a case where a numerical value of a communication amount, the number of sessions, a resource amount, or the like monitored by the security device or the like exceeds the set threshold value, the concerned communication is determined as a DDoS attack, and measures such as interruption or mitigation are taken.

In addition, Non Patent Literature 3 discloses a method in which traffic is sampled and collected by a network device such as a router or a switch, and then transferred in a flow traffic format such as NetFlow, and a DDoS attack is detected with a threshold value on the basis of statistical information included in the flow traffic. Using this method makes it also possible to detect a DDoS attack using a network device of a network operator.

At the time of introducing a security device, at the time of introducing a new application service, or at the time of changing the configuration of a network, for example, it is general to set a signature (attack detection method by pattern matching) or a threshold value so that whether a normal communication related to the service is erroneously detected and whether an attack communication is overlooked are verified in security operation for a certain period, and this verification period is referred to as staging.

Performing such staging gives advantages that setting a threshold value for a DDoS attack to an appropriate value makes it possible to improve the detection accuracy, and it is possible to find a setting error and an unnecessary signature.

On the other hand, changing the blocking setting to the alert setting by staging gives disadvantages that the security level is lowered and an operation cost related to setting confirmation and tuning analysis is incurred in the operation of staging.

As a method of shortening such staging, a method of performing verification in advance by trial application of a signature has been proposed (Non Patent Literature 4).

### CITATION LIST

### Non Patent Literature

Non Patent Literature 1: Cisco SCE 8000 10GBE Software Configuration Guide: Identification of DDoS attack and Defense against DDoS attack, https://www.cisco.com/c/ja_jp/td/docs/secg/servcntrl/servcn trloperatingsystems/cg/002/sce8000swcg/ddos.html
Non Patent Literature 2: Arbor Networks APS, https://www.nissho-ele.co.jp/product/arbor/arbor_aps.html
Non Patent Literature 3: Takanori Mizuguchi et al., “Traffic Analysis System SAMURAI and Service Deployment”, NTT Technical Journal, July 2008, http://www.ntt.co.jp/journal/0807/files/jn200807016.pdf
Non Patent Literature 4: General Catalog of F5 Products and Services, https://www.ntt-at.co.jp/product/big-ip/docs/F5Service_Family_Catalog.pdf

### SUMMARY OF INVENTION

### Technical Problem

As described above, in a case where a multi-vector DDoS attack is detected, it is effective to use an on-premises device, a cloud device, and a security service (for example, a DDoS mitigation service) in order to detect a plurality of types of attacks with high accuracy.

At the time of introducing a new application service, it is necessary to tune a threshold value of each device and security service so as to be able to detect a DDoS and accord with a provision form and a service level agreement (SLA) of each application service to be provided.

However, it is not easy to correctly set the threshold value in the entire network. In a case where the threshold value is not correctly set in the entire network, such an event may occur that a multi-vector DDoS attack may be overlooked, a normal communication may be erroneously detected, or the SLA may not be satisfied.

Furthermore, in the conventional technology, in order to individually set a threshold value in a plurality of device and security services, it is necessary to perform staging, which decreases the security level and increases the operation cost, as described above.

The present invention has been made in view of the above points, and an object of the present invention is to provide a technology capable of correctly performing security setting for a device on a network while a decrease in the security level and an increase in the operation cost are suppressed.

### Solution to Problem

According to the disclosed technology, there is provided a security setting support device that supports security setting for a device on a network, the security setting support device including:
a preliminary verification unit that performs preliminary verification for determining whether a security setting parameter is settable for the device based on a verification scenario including a feature amount obtained from traffic data in the network and the security setting parameter; and
a verification result output unit that outputs a result of the preliminary verification.

### Advantageous Effects of Invention

According to the disclosed technology, there is provided a technology capable of correctly performing security setting for a device on a network while a decrease in the security level and an increase in the operation cost are suppressed.

### BRIEF DESCRIPTION OF DRAWINGS

FIG. 1 is a system configuration diagram according to an embodiment of the present invention.

FIG. 2 is a diagram illustrating an exemplary structure of a network topology configuration DB.

FIG. 3 is a diagram illustrating an exemplary structure of a service information DB.

FIG. 4 is a diagram illustrating an exemplary structure of a device setting information DB.

FIG. 5 is a diagram illustrating an exemplary structure of a verification result storage DB.

FIG. 6 is a flowchart for describing an operation of a security setting support device.

FIG. 7 is a diagram illustrating an example of evaluating whether a threshold value for DDoS detection does not overlook a DDoS attack.

FIG. 8 is a diagram illustrating an example of evaluating whether a threshold value for DDoS detection erroneously detects a normal communication as a DDoS attack.

FIG. 9 is a diagram illustrating a hardware configuration example of a device.

### DESCRIPTION OF EMBODIMENTS

Hereinafter, an embodiment of the present invention (present embodiment) will be described with reference to the drawings. The embodiment described below is merely an example, and embodiments to which the present invention is applied are not limited to the following embodiment.

The present embodiment assumes a technology in which setting of a threshold value for detecting a multi-vector DDoS attack is supported for a plurality of devices of a network system. However, the technology according to the present embodiment is also applicable to DDoS attacks other than the multi-vector DDoS attack and attacks other than the DDoS attacks.

Furthermore, in the present embodiment, a threshold value for DDoS attack detection is used as a security setting parameter to be preliminarily verified, but the technology according to the present embodiment can also be applied to security setting parameters other than the threshold value.

In the present embodiment, a security setting support device converts traffic data related to an application service and a DDoS attack into feature amounts of numerical parameters, calculates a predicted value of a security setting parameter by preliminary verification simulation based on machine learning, and performs evaluation by preliminarily verifying security settings based on the predicted value, thereby providing security setting support. Hereinafter, a configuration and operation of the security setting support device will be described in detail.

### Device Configuration Example

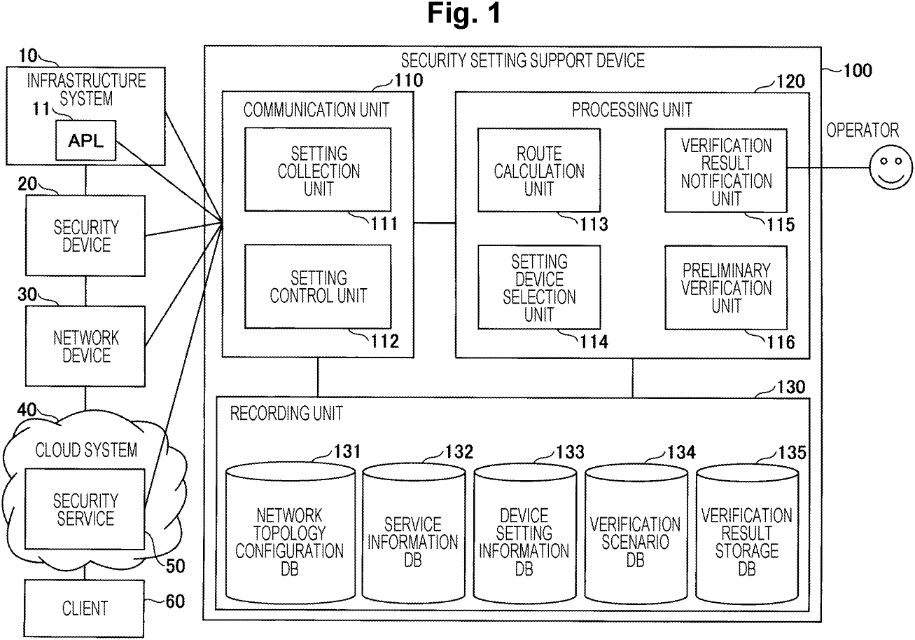

FIG. 1 illustrates a configuration example of a security setting support device 100 according to the present embodiment. FIG. 1 illustrates an APL 11 of an infrastructure system 10, a security device 20, a network device 30, a security service 50 of a cloud system 40, and the like as examples of devices and services for which the security setting support device 100 performs security setting. Note that the arrangement of devices and services for which the security setting support device 100 performs security setting, which is illustrated in FIG. 1, is an example, and the arrangement is not limited thereto. Furthermore, in FIG. 1, the function provided by the cloud system is referred to as a “service”, but the function provided by the cloud system may also be referred to as a “device”.

As illustrated in FIG. 1, the security setting support device 100 includes a communication unit 110, a processing unit 120, and a recording unit 130.

The communication unit 110 includes a setting collection unit 111 and a setting control unit 112. The processing unit 120 includes a route calculation unit 113, a setting device selection unit 114, a verification result notification unit 115, and a preliminary verification unit 116. A functional unit that performs setting control, such as the setting control unit 112, may be provided outside the security setting support device 100.

The recording unit 130 includes a network topology configuration database (DB) 131, a service information DB 132, a device setting information DB 133, a verification scenario DB 134, and a verification result storage DB 135. The function of each unit is as follows.

The setting collection unit 111 collects information regarding security settings from devices and services of a network system. Examples of the devices for which information is collected include a network device, a security device, an application server, an infrastructure system (Kubernetes, OpenStack, or the like) and the like. Examples of data to be collected include configuration information, SNMP data, flow traffic data (NetFlow, sFlow, or the like), and the like.

The route calculation unit 113 calculates network route information from a user client to an application service (infrastructure system or the like) on the basis of information in the network topology configuration DB 131.

The setting device selection unit 114 extracts devices for which security setting is performed on the basis of the network route information calculated by the route calculation unit 113.

The preliminary verification unit 116 executes preliminary verification simulation of a threshold value on the basis of a verification scenario, a security setting parameter, service information, and the like.

The verification result notification unit 115 notifies an operator of preliminary verification results. The verification result notification unit 115 displays a GUI on a terminal of the operator so that the operator can select confirmation of a verification result and determination of an instruction for security setting. Note that the verification result notification unit 115 may be referred to as a verification result output unit.

The setting control unit 112 performs security setting for each setting target device. The setting control destination is each device, but in a case of a device that mainly outputs flow traffic, such as a transfer device, a threshold value is set for a flow traffic analysis device. The flow traffic analysis device may be, for example, a device such as SAMURAI disclosed in Non Patent Literature 3.

Next, each DB in the recording unit 130 will be described.

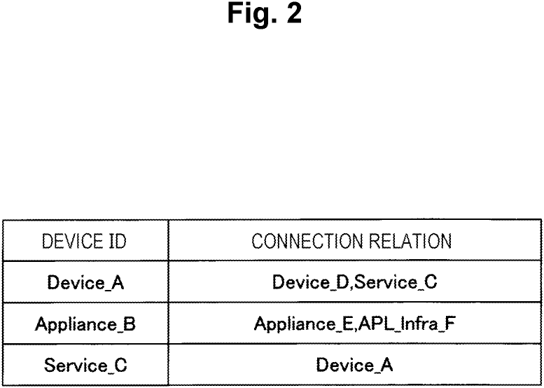

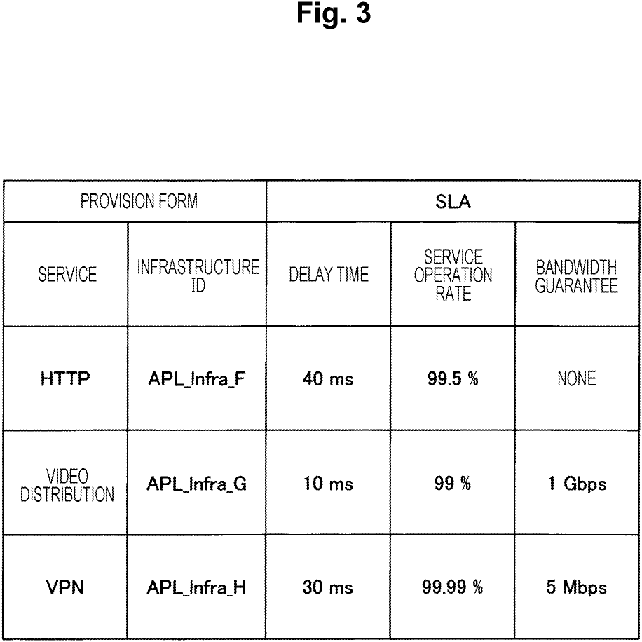

The network topology configuration DB 151 stores configuration information such as connection between devices in the network system. FIG. 2 illustrates an exemplary structure of the network topology configuration DB 151. The service information DB 132 stores information regarding a provision form and an SLA of application services. FIG. 3 illustrates an exemplary structure of the service information DB 132.

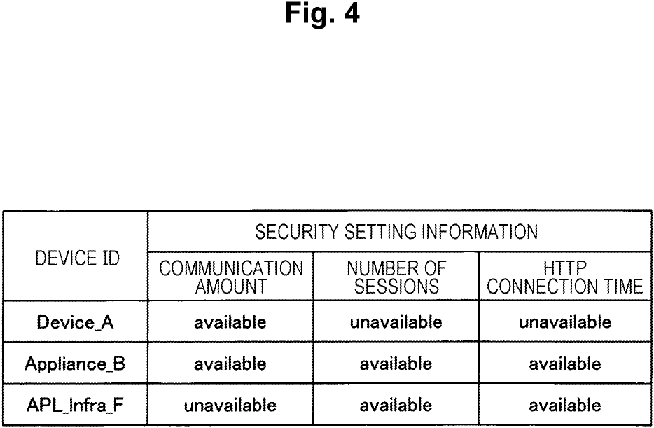

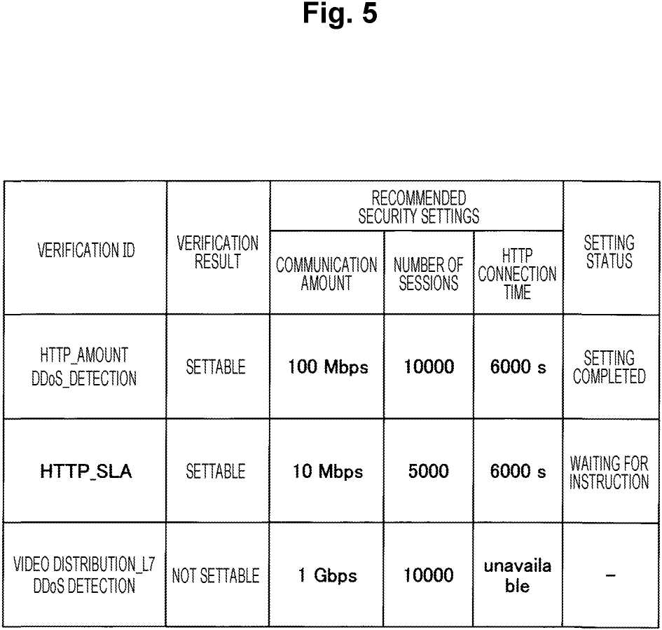

The device setting information DB 135 stores security setting information collected from target devices. FIG. 4 illustrates an exemplary structure of the device setting information DB 135. The verification scenario DB 134 stores verification scenarios (normal service/DDoS attack) obtained by converting traffic data into numerical feature amounts. The verification result storage DB 135 stores results of simulation verification in the preliminary verification unit 116. FIG. 5 illustrates an exemplary structure of the verification result storage DB 135. Main information stored in the DBs will be described below.

### Verification Scenario

First, the verification scenarios will be described. A verification scenario is a numerical parameter converted from traffic data in a certain service (for example, traffic data observed at a network device on a service route between a client and an infrastructure system) at the normal time or at the time of a DDoS attack, and is a feature amount indicating a feature of traffic.

The feature amount is, for example, a communication amount, the number of connections, a server resource amount, or the like. The feature amount may be a feature amount indicating a time-series change in the communication amount, the number of connections, the server resource amount, or the like. “The communication amount, the number of connections, the server resource amount, or the like” may be only the communication amount, only the number of connections, or only the server resource amount, may be a combination of any two of the communication amount, the number of connections, and the server resource amount, or may be all of the communication amount, the number of connections, and the server resource amount.

As verification scenarios, for example, numerical parameters at the normal time and at the time of a DDoS attack are prepared for each service. Traffic patterns of the concerned service are expressed by the concerned numerical parameters.

Examples of the traffic patterns used in the verification scenarios include a traffic pattern of an HTTP application, a traffic pattern of a video distribution application, a traffic pattern of a network bandwidth occupancy DDoS attack, and a traffic pattern of an application layer DDoS attack. The verification scenarios are created in advance and stored in the verification scenario DB 134. At the time of executing preliminary verification of security settings, the verification scenarios are read from the verification scenario DB 134 and used.

### Service Information

Regarding the service information, for each type of application service (HTTP, video distribution, VPN, and the like), identification information of an infrastructure system that provides the service and a service level agreement (SLA) of the service are input to the security setting support device 100, and the input information is stored in the service information DB 132. Examples of SLA items include a delay time, a service operation rate, a bandwidth guarantee, and the like as illustrated in FIG. 3.

### Security Setting Information

As the security setting information, information indicating whether a threshold value for DDoS attack detection is settable (available/unavailable) is acquired from each device and service, and is stored in the device setting information DB 135 as illustrated in FIG. 4. In the example of FIG. 4, for example, regarding Device_A, it is indicated that a threshold value for the communication amount is settable, but threshold values for the number of sessions and HTTP connection time are not settable. The security setting information illustrated in FIG. 4 is used when the setting control unit 112 sets a threshold value for each device and service. For example, for a certain device, a threshold value of an item that is available (for example, communication amount) is set, and a threshold value of an item that is unavailable (for example, the number of sessions) is not set.

### (Operation Example of Security Setting Support Device 100)

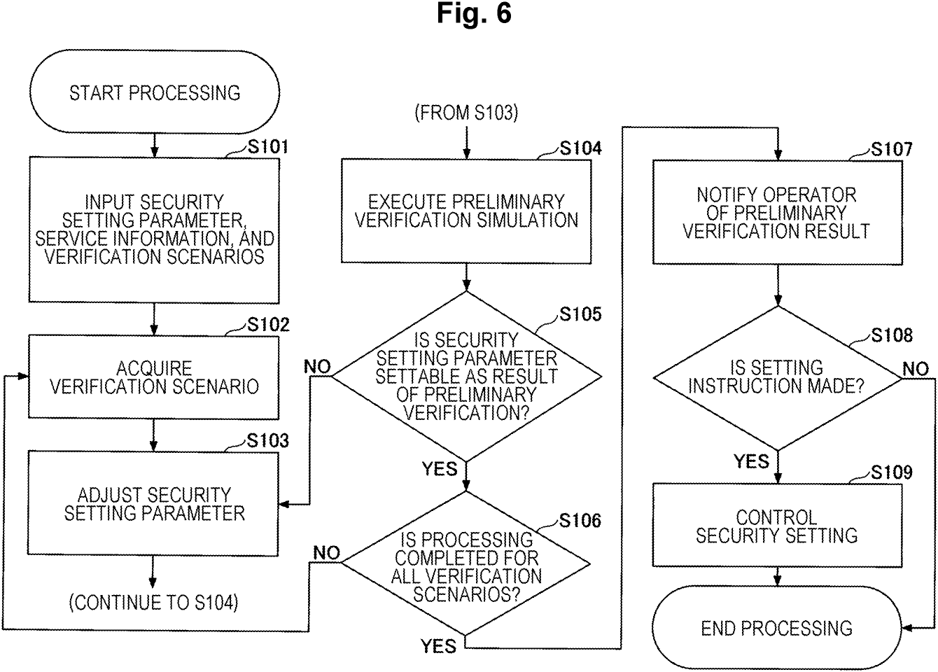

FIG. 6 is a flowchart for describing an operation example related to preliminary verification of security settings by the security setting support device 100. The operation example of the security setting support device 100 will be described along the procedure of the flowchart of FIG. 6.

### S101

In S101, the preliminary verification unit 116 reads service information of an application service from the service information DB 132, and reads verification scenarios from the verification scenario DB 134. In addition, a security setting parameter (specifically, a threshold value) to be preliminarily verified is input. The security setting parameter is input to the security setting support device 100 by an operator using the GUI of the verification result notification unit 115, for example.

For example, in a case where an HTTP service is targeted as the application service, the preliminary verification unit 116 reads an SLA of the HTTP service from the service information DB 132.

Furthermore, as for the verification scenarios, in a case where the HTTP service is targeted as in the above example, the preliminary verification unit 116 reads a verification scenario corresponding to a traffic pattern of an HTTP application at the normal time and a verification scenario corresponding to a traffic pattern at the time of a DDoS attack. As the verification scenario corresponding to the traffic pattern at the time of a DDoS attack, a plurality of verification scenarios may be read according to types of DDoS attacks on the service (HTTP service).

Furthermore, in a case where preliminary verification is performed for the HTTP service, a threshold value for detecting a DDoS attack on the HTTP service is input to the preliminary verification unit 116 as a security setting parameter. For example, values such as the communication amount = 100 Mbps, the number of sessions = 10000, and the HTTP connection time = 600 s are input as security setting parameters for preliminary verification simulation.

### S102 to S106

In S102, the preliminary verification unit 116 acquires one verification scenario of the plurality of verification scenarios.

In S103, the preliminary verification unit 116 adjusts the security setting parameter used in the preliminary verification simulation. However, the input security setting parameter is used before execution of the preliminary verification simulation.

In S104, the preliminary verification unit 116 executes the preliminary verification simulation using the service information, the security setting parameter, and the verification scenario.

In the present embodiment, preliminary verification simulation by machine learning is performed. The machine learning method is not limited to a specific method, and it is possible to use a supervised machine learning method widely and generally used.

As an example, the preliminary verification simulation can be performed by use of a model configured by a neural network.

In the case of using the above model, for example, the model is learned by supervised learning, and the learned model (specifically, a learned weight parameter or the like) is stored in the preliminary verification unit 116. The preliminary verification unit 116 inputs the security setting parameter, the verification scenario, and the like to the model, and determines whether the security setting parameter is settable on the basis of an output from the model.

In the learning, for example, processing of inputting learning data to the above model, comparing an output from the model (for example, being settable or not being settable) with a correct answer, and adjusting parameters of the model such that the output is close to the accuracy is performed for a large number of pieces of learning data.

Regarding the learning data, for example, in a case where it is known that a correct answer is that a certain security setting parameter (referred to as a threshold value B for DDoS attack detection) is not settable (for example, a DDoS attack cannot be detected) for a certain verification scenario (referred to as a feature amount A indicating a traffic pattern at the time of the DDoS attack), the learning data is “feature amount A, threshold value B, not being settable”.

In this case, “feature amount A, threshold value B” is input to the model, an output from the model is compared with the correct answer “not being settable”, and the parameters are adjusted. Such processing is performed by use of a large number of pieces of learning data prepared in advance.

The learning processing of the model may be executed by the security setting support device 100 or may be executed by a computer outside the security setting support device 100.

In addition, a correct answer of learning data may be information indicating whether a security setting parameter is settable, as described above, or may be a recommended security setting parameter (recommended threshold value). In a case of using a model learned by use of learning data having recommended security setting parameters (recommended threshold values) as correct answers of the learning data, a recommended security setting parameter (recommended threshold value) is output if the recommended security setting parameter is settable as a result of preliminary verification.

In S105, the preliminary verification unit 116 confirms whether the security setting parameter is settable as a result of the preliminary verification simulation. If the security setting parameter is not settable, the security setting parameter is adjusted (for example, the threshold value may be increased or decreased) in S103, the preliminary verification simulation is executed again by use of the adjusted security setting parameter (S104), and a result of the simulation is confirmed (S105). This processing is repeated until the security setting parameter is “settable” as a result of the simulation, and when the security setting parameter is settable, the processing proceeds to S106. Note that, when the processing is repeated a predetermined number of times, the processing may proceed to S106 even if the security setting parameter is “not settable”. The processing of S102 to S105 is executed for all the target verification scenarios (S106).

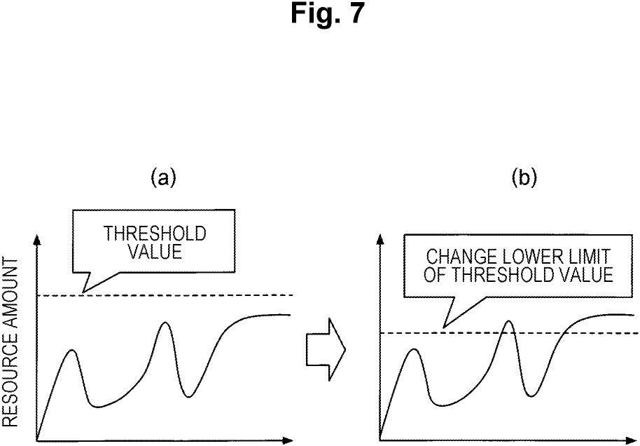

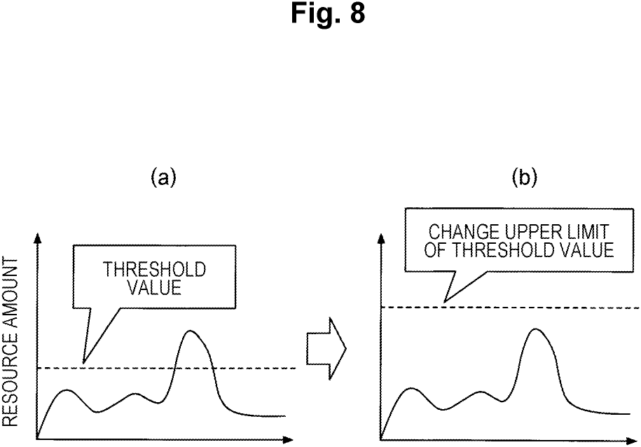

Specific examples of evaluation by preliminary verification simulation will be described with reference to FIGS. 7 and 8.

FIG. 7 illustrates an example of evaluating whether a threshold value for DDoS detection does not overlook a DDoS attack.

FIG. 7(a) illustrates a state in which a DDoS attack is overlooked as a result of performing preliminary verification simulation with a certain threshold value for a certain verification scenario (= a feature amount indicating a traffic pattern of the DDoS attack) (that is, the threshold value is not settable). In this case, as illustrated in FIG. 7(b), the preliminary verification unit 116 decreases the threshold value and executes the preliminary verification simulation again.

FIG. 8 illustrates an example of evaluating whether a threshold value for DDoS attack detection erroneously detects a normal communication as a DDoS attack.

FIG. 8(a) illustrates a state in which a normal communication is erroneously detected as a DDoS attack as a result of performing preliminary verification with a certain threshold value for a certain verification scenario (= a feature amount indicating a traffic pattern of the normal communication) (that is, the threshold value is not settable). In this case, as illustrated in FIG. 8(b), the preliminary verification unit 116 increases the threshold value and executes the preliminary verification simulation again.

In addition, as evaluation by preliminary verification simulation, it is possible to evaluate whether security settings satisfy an SLA of an application service. Examples of the SLA include a delay time, a service operation rate, bandwidth guarantee, and the like. For example, in preliminary verification simulation in which a certain threshold value is set for DDoS attack detection, in a case where the delay time exceeds the SLA when the threshold value is used (that is, in a case where the threshold value is not settable), adjustment to change the threshold value is performed.

The evaluation as described above can be implemented by use of a model learned with a large number of learning data including various threshold values, various assumed verification scenarios, and correct answers (for example, a DDoS attack is detected or overlooked, a normal communication is erroneously detected or not erroneously detected, and an SLS is satisfied or not satisfied).

### S107 to S109

In S107 of FIG. 6, the verification result notification unit 115 notifies the operator of a preliminary verification result.

For example, in a case where preliminary verification is performed for the HTTP service and a preliminary verification result indicating that the security setting parameter is “settable” is obtained, the verification result notification unit 115 notifies the operator of information indicating that the security setting parameter is “settable” as a result of the preliminary verification for the HTTP service. Furthermore, for example, in a case where preliminary verification is performed for the HTTP service and a preliminary verification result indicating that the security setting parameter is “not settable” is obtained, the verification result notification unit 115 notifies the operator of information indicating that the security setting parameter is “not settable” as a result of the preliminary verification for the HTTP service.

For example, in the case of receiving the notification that the security setting parameter is “settable”, the operator instructs the security setting support device 100 to perform setting (Yes in S108). In this case, in S109, the setting control unit 112 sets the security setting parameter (threshold value) determined to be settable in the preliminary verification for a setting target device and service.

For example, it is assumed that, as a result of the preliminary verification, the communication amount = 100 Mbps, the number of sessions = 10000, and the HTTP connection time = 6000 s, which are security setting parameters (specifically, threshold values for DDoS attack detection), are determined to be “settable” in the preliminary verification simulation.

In addition, the route calculation unit 113 selects the setting target device and service that are present on the route for the target service on the basis of a setting target infrastructure ID acquired from the service information DB 132 and information in the network topology configuration DB 131, and passes a result of the selection to the setting control unit 112. Furthermore, security setting information regarding the setting target device and service is acquired from the device setting information DB 135.

Assuming that the setting target device is a network device A, and that security setting information of the network device A indicates “the communication amount = available”, “the number of sessions = unavailable”, and “the HTTP connection time = unavailable”, the setting control unit 112 sets the communication amount = 100 Mbps as a security setting parameter for the network device A.

### Hardware Configuration Example

The security setting support device 100 according to the present embodiment can be implemented, for example, by a computer executing a program in which processing contents described in the present embodiment are described. Note that the “computer” may be a physical machine or a virtual machine on a cloud. In a case where a virtual machine is used, “hardware” described herein is virtual hardware.

The above program can be stored and distributed by being recorded in a computer-readable recording medium (portable memory or the like). Furthermore, the above program can also be provided through a network such as the Internet or an electronic mail.

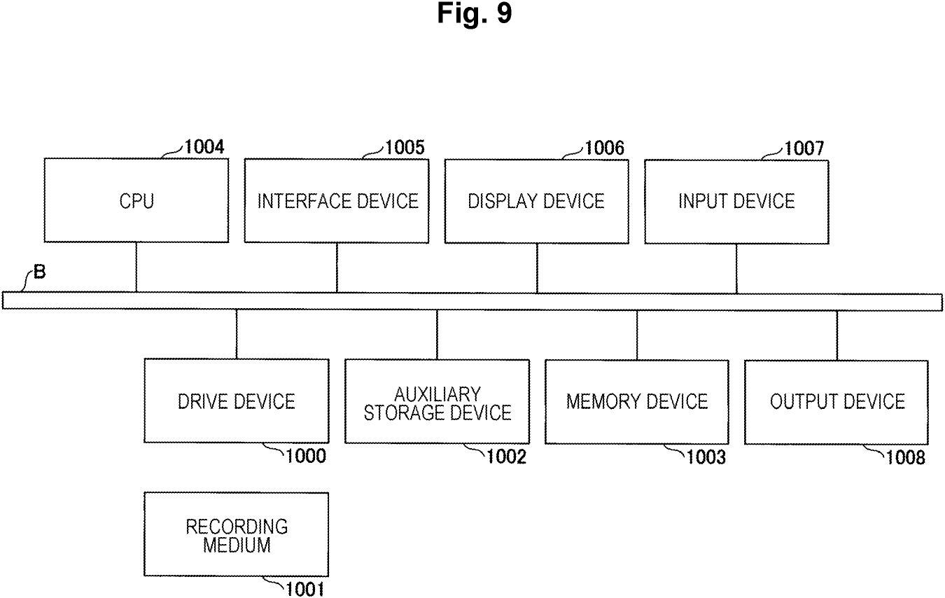

FIG. 9 is a diagram illustrating a hardware configuration example of the above computer. The computer in FIG. 9 includes a drive device 1000, an auxiliary storage device 1002, a memory device 1003, a CPU 1004, an interface device 1005, a display device 1006, an input device 1007, an output device 1008, and the like, which are connected to each other by a bus BS.

The program for implementing the processing in the computer is provided by a recording medium 1001 such as a CD-ROM or a memory card. When the recording medium 1001 storing the program is set in the drive device 1000, the program is installed from the recording medium 1001 to the auxiliary storage device 1002 via the drive device 1000. However, the program is not necessarily installed from the recording medium 1001, and may be downloaded from another computer via a network. The auxiliary storage device 1002 stores the installed program and also stores necessary files, data, and the like.

In a case where an instruction to start the program is made, the memory device 1003 reads and stores the program from the auxiliary storage device 1002. The CPU 1004 implements a function related to the security setting support device 100 according to the program stored in the memory device 1003. The interface device 1005 is used as an interface for connecting to the network. The display device 1006 displays a graphical user interface (GUI) or the like by the program. The input device 1007 includes a keyboard and mouse, buttons, a touch panel, or the like, and is used to input various operation instructions. The output device 1008 outputs a calculation result.

### Effects and the Like of Embodiment

With the technology according to the present embodiment, setting a threshold value related to DDoS detection in a plurality of devices and security services after preliminary verification makes it possible to detect a multi-vector DDoS attack with high accuracy even if staging is shortened. As a result, it is possible to prevent occurrence of erroneous detection and overlooking due to incorrect setting of the threshold value for DDoS detection.

Furthermore, with the technology according to the present embodiment, preliminary verification enables efficient security setting, and shortening the staging period makes it possible to continuously secure the security level and reduce the operation cost at the time of introducing a new service or each time the NW configuration is changed. As a result, it is possible to suppress a decrease in the security level and an increase in the operation cost due to the staging execution.

That is, in the technology according to the present embodiment, a traffic pattern or the like obtained from a real environment is converted into numerical feature amount data, and then security settings are evaluated by simulation using a machine learning method, instead of verification using a real device and a real service in a verification environment, so that the operation cost and the verification cost can be reduced.

### Summary of Embodiment

In this specification, at least a security setting support device, a security setting support method, and a program described in the following clauses are described.

### Clause 1

A security setting support device that supports security setting for a device on a network, the security setting support device including:
a preliminary verification unit that performs preliminary verification for determining whether a security setting parameter is settable for the device based on a verification scenario including a feature amount obtained from traffic data in the network and the security setting parameter; and
a verification result output unit that outputs a result of the preliminary verification.

### Clause 2

The security setting support device according to clause 1, further including a setting control unit that sets, for the device, a security setting parameter determined to be settable by the preliminary verification unit.

### Clause 3

The security setting support device according to clause 1 or 2, wherein

the preliminary verification unit makes the determination by performing preliminary verification simulation by use of a learned model learned by supervised machine learning.

### Clause 4

The security setting support device according to any one of clauses 1 to 3, wherein

in a case where it is determined that the security setting parameter is not settable for the device, the preliminary verification unit changes the security setting parameter and makes the determination again by use of the changed security setting parameter.

### Clause 5

The security setting support device according to any one of clauses 1 to 4, wherein

the security setting parameter is a threshold value for detecting a DDoS attack on the network.

### Clause 6

The security setting support device according to clause 5, wherein

the preliminary verification unit makes the determination based on whether a DDoS attack is not overlooked by the threshold value, whether a normal communication is not erroneously detected as a DDoS attack by the threshold value, or whether an SLA of a service is satisfied by the threshold value.

### Clause 7

A security setting support method executed by a security setting support device that supports security setting for a device on a network, the security setting support method including:
a preliminary verification step of performing preliminary verification for determining whether a security setting parameter is settable for the device based on a verification scenario including a feature amount obtained from traffic data in the network and the security setting parameter; and
a verification result output step of outputting a result of the preliminary verification.

### Clause 8

A program for causing a computer to function as each unit in the security setting support device according to any one of clauses 1 to 6.

Although the present embodiment has been described above, the present invention is not limited to such a specific embodiment, and various modifications and changes can be made within the scope of the gist of the present invention described in the claims.

Reference Signs List

| | |
|---|---|
| 10 | Infrastructure system |
| 11 | APL |
| 20 | Security device |
| 30 | Network device |
| 40 | Cloud system |
| 50 | Security service |
| 60 | Client |
| 100 | Security setting support device |
| 110 | Communication unit |
| 120 | Processing unit |
| 130 | Recording unit |
| 111 | Setting collection unit |
| 112 | Setting control unit |
| 113 | Route calculation unit |
| 114 | Setting device selection unit |
| 115 | Verification result notification unit |
| 116 | Preliminary verification unit |
| 131 | Network topology configuration DB |
| 132 | Service information DB |
| 133 | Device setting information DB |
| 134 | Verification scenario DB |
| 135 | Verification result storage DB |
| 1000 | Drive device |
| 1001 | Recording medium |
| 1002 | Auxiliary storage device |
| 1003 | Memory device |
| 1004 | CPU |
| 1005 | Interface device |
| 1006 | Display device |
| 1007 | Input device |
| 1008 | Output device |

We claim:

1. A security setting support device for supporting security setting for a device on a network, the security setting support device comprising:
a preliminary verification unit, including one or more processors, configured to perform preliminary verification for determining whether a security setting parameter is settable for the device based on a verification scenario including a feature amount obtained from traffic data in the network and the security setting parameter; and
a verification result output unit, including one or more processors, configured to output a result of the preliminary verification.

2. The security setting support device according to claim 1, further comprising
a setting control unit, including one or more processors, configured to set, for the device, a security setting parameter determined to be settable by the preliminary verification unit.

3. The security setting support device according to claim 1, wherein
the preliminary verification unit is configured to make the determination by performing preliminary verification simulation by use of a learned model learned by supervised machine learning.

4. The security setting support device according to claim 1, wherein
in a case where it is determined that the security setting parameter is not settable for the device, the preliminary verification unit is configured to change the security setting parameter and make the determination again by use of the changed security setting parameter.

5. The security setting support device according to claim 1, wherein
the security setting parameter is a threshold value for detecting a DDoS attack on the network.

6. The security setting support device according to claim 5, wherein
the preliminary verification unit is configured to make the determination based on whether a DDoS attack is not overlooked by the threshold value, whether a normal communication is not erroneously detected as a DDoS attack by the threshold value, or whether an SLA of a service is satisfied by the threshold value.

7. A security setting support method executed by a security setting support device that supports security setting for a device on a network, the security setting support method comprising:
a preliminary verification step of performing preliminary verification for determining whether a security setting parameter is settable for the device based on a verification scenario including a feature amount obtained from traffic data in the network and the security setting parameter; and
a verification result output step of outputting a result of the preliminary verification.

8. A non-transitory computer-readable storage medium storing a program for causing a computer to function as a security setting support device for supporting security setting for a device on a network to perform operations comprising:
performing preliminary verification for determining whether a security setting parameter is settable for the device based on a verification scenario including a feature amount obtained from traffic data in the network and the security setting parameter; and
outputting a result of the preliminary verification.

9. The non-transitory computer-readable storage medium according to claim 8, wherein the operations further comprise:
setting, for the device, a security setting parameter determined to be settable by the preliminary verification unit.

10. The non-transitory computer-readable storage medium according to claim 8, wherein the operations further comprise:
making the determination by performing preliminary verification simulation by use of a learned model learned by supervised machine learning.

11. The non-transitory computer-readable storage medium according to claim 8, wherein the operations further comprise:
in a case where it is determined that the security setting parameter is not settable for the device, changing the security setting parameter and makes the determination again by use of the changed security setting parameter.

12. The non-transitory computer-readable storage medium according to claim 8, wherein
the security setting parameter is a threshold value for detecting a DDoS attack on the network.

13. The non-transitory computer-readable storage medium according to claim 12, wherein the operations further comprise:
making the determination based on whether a DDoS attack is not overlooked by the threshold value, whether a normal communication is not erroneously detected as a DDoS attack by the threshold value, or whether an SLA of a service is satisfied by the threshold value.

14. The security setting support method according to claim 7, further comprising:
setting, for the device, a security setting parameter determined to be settable by the preliminary verification unit.

15. The security setting support method according to claim 7, further comprising:
making the determination by performing preliminary verification simulation by use of a learned model learned by supervised machine learning.

16. The security setting support method according to claim 7, further comprising:
in a case where it is determined that the security setting parameter is not settable for the device, changing the security setting parameter and makes the determination again by use of the changed security setting parameter.

17. The security setting support method according to claim 7, wherein
the security setting parameter is a threshold value for detecting a DDoS attack on the network.

18. The security setting support method according to claim 17, further comprising:
making the determination based on whether a DDoS attack is not overlooked by the threshold value, whether a normal communication is not erroneously detected as a DDoS attack by the threshold value, or whether an SLA of a service is satisfied by the threshold value.
